(19) United States
(12) Patent Application Publication
(10) Pub. No.: US 2010/0115864 A1
(43) Pub. Date: May 13, 2010

(54) Adjustable Frame Assembly for Fire Rated Building Opening

(75) Inventors: Robert de La Fontaine, Sherbrooke (CA); Michel Dionne, Stoke (CA); Stephane Jeanson, Sherbrooke (CA)

Correspondence Address: DIEDERIKS & WHITELAW, PLC, 13885 HEDGEWOOD DR., SUITE 317, WOODBRIDGE, VA, 22193, US

(73) Assignee: DE LA FONTAINE INDUSTRIES, Sherbrooke (CA)

(21) Appl. No.: 12/617,402

(22) Filed: Nov. 12, 2009

Related U.S. Application Data
(60) Provisional application No. 61/113,798, filed on Nov. 12, 2008.

(51) Int. Cl. E06B 1/04; E06B 1/20; E06B 1/60; E06B 1/18

(52) U.S. Cl. 52/217; 52/745.16

(57) ABSTRACT

An adjustable frame assembly for a door, window or other opening in a building utilizes sets of first and second brackets to secure a frame component along a side of the opening in a manner which allows for easy adjustment in the width and depth of the mounted members. The first bracket is formed with a first flange portion extending outside the opening and a second flange portion projecting inside the opening, while the second bracket extends from the frame component. The second flange portion of the first bracket is adjustably secured to the frame component through the second bracket, potential with an interposed, varying width accommodating spacer member, such that the first frame component is secured to the wall stud through the first and second brackets with a distance between a facer portion of the first frame component and the first flange portion being adjustable.

### CROSS-REFERENCE TO RELATED APPLICATIONS

The present invention claims the benefit of U.S. Provisional Patent Application Ser. No. 61/113,798 entitled “Adjustable Frame Assembly for Fire Rated Building Opening” filed Nov. 12, 2008.

### BACKGROUND OF THE INVENTION

1. Field of the Invention

The present invention pertains to the construction field and, more particularly, to an adjustable door, window or the like frame assembly for use in building construction. Even more specifically, the invention is directed to fixedly mounting a versatile frame assembly in a framed building opening in a simple, adjustable manner while establishing a high fire rating.

2. Discussion of the Prior Art

In the construction industry, it is common to establish internal wall openings for doors, windows, closable pass-throughs and the like. As there actually exists a range in the size of the openings, specifically variations in at least both lateral and thickness dimensions, pre-manufactured frames that vary in size are available. To minimize the number of frame configurations which need to be produced, it is known to produce a frame, such as a door frame, which is adjustable in thickness. Such an adjustable frame assembly is particularly common in connection with metal door frames which can be used in residential construction but are more typically found in commercial building construction. For example, a typical adjustable metal door frame assembly will include a pair of hinge jamb components, a pair of striker jamb components and a pair of header components, with the pairs being joined through respective tongue and groove connections. More specifically, each of the grooved jamb and header components are fixed along one side of the doorway and then the other jamb and header components are slid into position from the other side of the doorway, with a tongue portion of each of the other jamb and header components being received in a respective groove of the fixed jamb and header components until flange or facer portions of the sliding components abut the wall. With this arrangement, the tongue and groove connections permit a single door frame assembly to be used with walls which vary in thickness.

Certainly, it is desired to mount the fixed frame components in a manner which will establish a rigid and sturdy assembly, particularly in the case of metal door frames given the fact that such metal door frames are typically used to support relatively heavy metal doors. In the past, numerous mounting configurations have been proposed in an attempt to achieve a sturdy and robust assembly, while attempting to provide for a relatively easy mounting sequence for the door assembly. Regardless of the availability of various mounting arrangements, there still exists a need for an enhanced mounting system for the fixed components of an adjustable metal frame assembly, particularly the fixed hinge jamb component of a metal door frame assembly.

### SUMMARY OF THE INVENTION

The present invention is directed to an adjustable frame assembly and, more particularly, to a mounting arrangement for one or more of the fixed components of a multi-component adjustable frame assembly. In accordance with a preferred embodiment of the invention, the frame assembly is used to mount a door such that the overall door frame assembly includes hinge jamb, striker jamb and header components, with each of these components being formed from two separate members, i.e., a fixed member and a slidingly interconnected member, which enable the adjustable door frame assembly to be used with walls having varying thicknesses. However, the overall adjustable frame assembly of the invention can extend to other types of openings, such as internal windows, pass-through zones and the like. One particular aspect of the present invention is concerned with the manner in which the fixed members of a door frame assembly are mounted and, most importantly, the mounting of at least the fixed member of the hinge jamb component.

In accordance with the adjustable frame assembly of the invention, a rigid and sturdy frame construction is preferably established utilizing sets of brackets to secure one or more fixed frame components to one side of an opening, such as a doorway. In a first embodiment of the invention, each set includes two brackets. A first one of the brackets includes one portion which slips between a stud defining the opening and an adjacent wallboard and another portion which extends along the stud and is mechanically secured thereto. The second of the two brackets is fixed to or integrally formed with a respective fixed frame component. The two brackets are interconnected to indirectly fix the frame component to the wall.

Once all the fixed frame members are secured, such as in a corresponding manner to the fixed hinge jamb member described, the other frame members can be readily slid into place and preferably joined by a friction fit. In further accordance with the present invention, an optional spacer plate arrangement can be installed between the first and second brackets in order to accommodate varying opening widths for the overall frame assembly. Therefore, with this arrangement, the adjustable frame assembly can accommodate door or other opening variations in both thickness and width. Even with the simply, yet enhanced mounting arrangement, the construction of the overall frame assembly enables a high fire rating to be obtained.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a perspective view of a portion of a partially assembled adjustable door frame constructed in accordance with the present invention;

FIG. 2 is an exploded view of the assembly of FIG. 1;

FIG. 3 is an exploded view of the connection arrangement for the adjustable door frame of the invention, with the connection arrangement being shown including an optional spacer member;

FIG. 4A illustrates an alternative bracket arrangement for the adjustable frame assembly of the invention;

FIG. 4B is an exploded view of the bracket arrangement of FIG. 4A;

FIG. 5 is a partial exploded view of an overall frame assembly constructed in accordance with the invention and utilizing the bracket arrangement of FIGS. 4A and 4B;

FIG. 6 is an enlarged, perspective view of the mounting of one bracket arrangement shown in FIG. 5;

FIG. 7 is a side view of the bracket arrangement of FIG. 6;

FIG. 8 is an exploded view similar to FIG. 3 but of a modified frame assembly according to the overall invention;

FIG. 9 shows free end structure of a preferred embodiment of the frame assembly;

FIG. 10 is a perspective view of a multi-piece shipping support used in connection with a door frame assembly constructed in accordance with the present invention; and

FIG. 11 shows an opening in which is mounted the adjustable door frame assembly with the shipping support of FIG. 10.

### DETAILED DESCRIPTION OF THE PREFERRED EMBODIMENTS

As will become more fully evident below, the adjustable frame assembly of the invention can be employed to frame out various different construction openings, such as door, window, pass-through and the like type openings commonly found in construction settings. For exemplary purposes, a detailed description will be made in setting forth preferred embodiments for an adjustable door frame assembly. However, the basic principles described can also be applied in connection with other types of openings found in the construction industry.

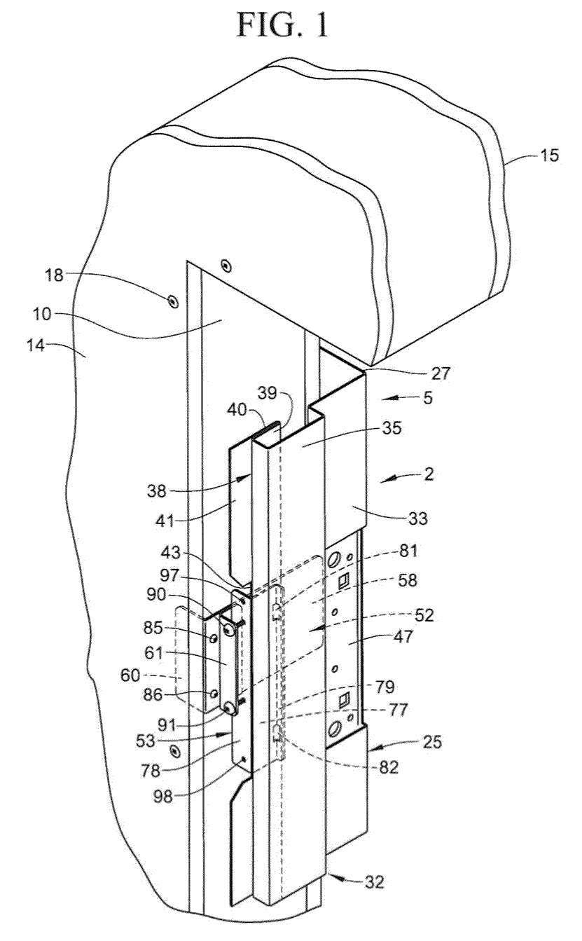

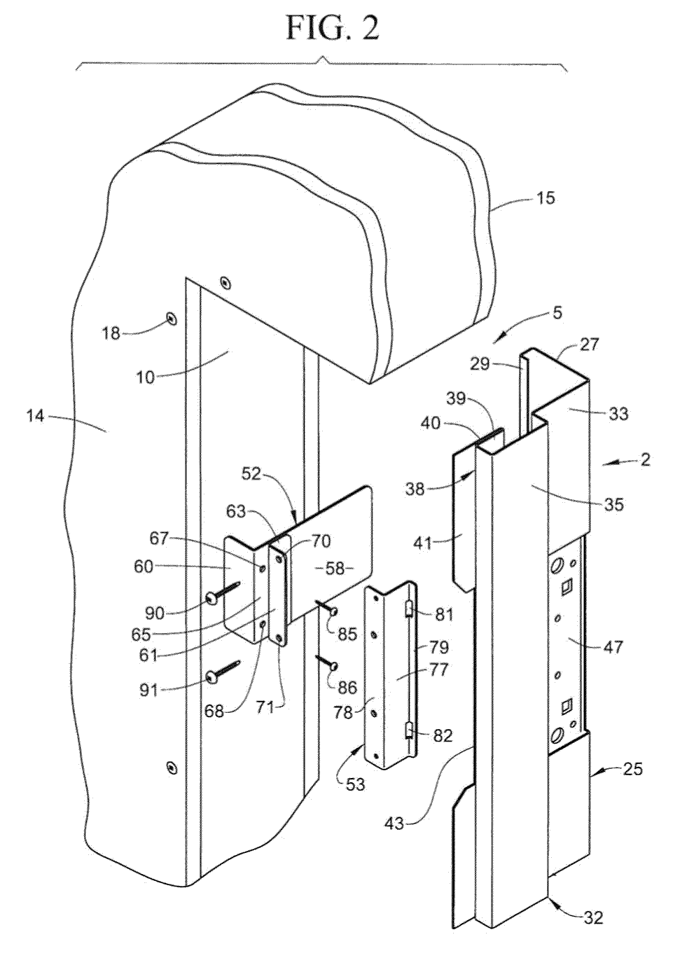

With initial reference to FIGS. 1 and 2, an adjustable door frame assembly constructed in accordance with the present invention is generally indicated at 2. Adjustable door frame assembly 2 is adapted to be mounted within a door opening indicated at 5 which is defined, at least in part, by a wall stud 10 to which is secured, on opposing sides thereof, wall coverings 14 and 15 by means of screws, one of which is indicated at 18. At this point, it should be noted that wall coverings 14 and 15 can take the form of various wallboard materials, but is generally constituted by gypsum sheetrock. It should also be noted at this point that the main components of door frame assembly 2 take a form corresponding to that known in the art. More particularly, the overall door frame assembly 2 includes hinge jamb, striker jamb and header components, with each of these components being formed from two separate members, i.e., a fixed member and a sliding interconnected member. This type of general adjustable door frame assembly is widely known in the art, such as represented by U.S. Pat. No. 5,187,898 which is incorporated herein by reference. In any case, these general adjustable door frame assembly components are used with walls having varying thicknesses. Of particular concern to the present invention is the manner in which the fixed components of door frame, assembly 2 are mounted and, most importantly, the mounting of at least the fixed member of the hinge jamb component, with the fixed hinge jamb component being shown at 25 in these figures.

As depicted, fixed hinge jamb component 25 includes a facer portion 27 that terminates in an in-turned edge 29. Again, as known in the art, facer portion 27 is adapted to be positioned against one wall covering 15 upon mounting of door frame assembly 2, while an inside section 32 of hinge jamb component 25 extends adjacent wall stud 10 within door opening 5. Along inside section 32 is defined a recessed, door receiving portion 33 which leads to a door abutment or stop portion 35. Door abutment portion 35 leads to a channel or groove 38 defined by an in-turned portion 39 leading to an out-turned portion 40 that terminates at a lip 41. As shown, lip 41 includes a cut-out section 43 that is established juxtaposed a hinge mounting zone 47 formed in door rebate portion 33. As should be readily apparent, hinge mounting zone 47 includes a plurality of openings (not separately labeled) and is adapted to mount one end of a hinge for a door associated with door frame assembly 2, with the door also not being shown in these figures for simplicity.

At this point, it should be readily apparent that hinge jamb component 25 will include a plurality of vertically spaced hinge mounting zones 47. In accordance with the invention, sets of brackets are employed to secure hinge jamb component 25 to wall stud 10 at door opening 5. Below is provided a detailed description of one set of the brackets associated with hinge mounting zone 47 depicted in FIGS. 1 and 2. At the same time, it should be recognized that additional sets of brackets would be employed along the length of hinge jamb component 25 in connection with the overall mounting. Certainly, hinge jamb component 25 of adjustable door frame assembly 2 requires the most rigid and sturdy mounting arrangement of all the door frame components. Therefore, at this point, it should be understood that all of the door frame components can be mounting in a corresponding fashion to that described in detail below, or the striker jamb and header components can be mounted in a more conventional manner.

In a first embodiment of the invention, each set of brackets includes two brackets 52 and 53. In accordance with this preferred embodiment, the first bracket 52 includes an elongated main plate portion 58 from which projects two flange portions 60 and 61. In one preferred construction, the first bracket 52 is formed by bending a metal plate into a generally L-shaped configuration to establish main plate portion 58 and flange portion 60, with flange portion 60 extending substantially perpendicular to main plate portion 58. The second flange portion 61 is provided at a position spaced along main plate portion 58 from first flange portion 60, with second flange portion 61 also extending substantially perpendicular from main plate portion 58, but in a direction opposite from first flange portion 60. As shown, second flange portion 61 is actually part of an angled bracket section including a leg 63 which is welded or otherwise affixed to main plate portion 58 at a position spaced from first flange portion 60 by a section 65 of main plate portion 58. Therefore, with this configuration, the first and second flange portions 60 and 61 are arranged in spaced, generally parallel planes. The main plate portion 58 of first bracket 52 is formed with a plurality of spaced apertures 67, 68 and the second flange portion 61 is also formed with a plurality of spaced apertures 70, 71.

The second bracket 53 is fixed to, such as by welding, or integrally formed with the respective fixed frame component 25. In accordance with a preferred embodiment of the invention, second bracket 53 is made of metal and bent to assume a generally Z-shaped cross-section. In any case, second bracket 53 is formed with at least first and second leg portions 77 and 78, with the first leg portion 77 extending along frame component 25 and second leg portion 78 projecting from frame component 25, preferably at a substantially perpendicular angle. In the most preferred form of the invention, the second leg portion 78 has an associated length which is longer than a corresponding length of the second flange portion 61 of first bracket 52. As shown in its most preferred form, second bracket 53 includes a third leg 79 including spaced slots 81 and 82. In this form, second bracket 53 is preferably welded to fixed door jamb component 25 along third leg 79.

First bracket 52 is configured to be mounted to wall stud 10 defining door opening 5, with first flange portion 60 being slipped between an edge of wall stud 10 and the adjacent wall covering 14. Once first flange portion 60 is appropriately positioned, main plate portion 58 of first bracket 52 will abut and extend along an exposed face of stud 10. At this point, holes (not shown) are drilled in stud 10 in alignment with the plurality of apertures 67 and 68 in main plate portion 58 of first bracket 52 and mechanical fasteners, such as self-tapping sheet metal screws 85 and 86 (or wood screws for wood stud applications), are used to fixedly secure first bracket 52 to stud 10. Again, it should be understood that multiple sets of brackets are utilized in the mounting of the door frame components such that one or more additional first brackets would be mounted at this stage in a corresponding manner. In a preferred form of the invention, at least three sets of brackets are employed in connection with mounting hinge jamb component 25, with the sets of brackets being provided at the level of each door hinge.

Once the desired number of first brackets are mounted, the respective fixed frame component 25 is put in place, with facer portion 27 of fixed frame component 25 abutting wall 15 defining door opening 5. Once fixed frame component 25 is in position, the second leg portion 78 of each of the second brackets 53 will be arranged behind the second flange portion 61 of a respective first bracket 52. The spacing between the second leg portion 78 and the second flange portion 61 will vary depending on the thickness of wall 10. Regardless, holes (not labeled) are drilled through second leg portion 78 in alignment with the plurality of apertures 70 and 71 in second flange portion 61. Thereafter, adjustable connectors, shown in the form of elongated screws 90 and 91, are inserted into the plurality of apertures 70 and 71 and threaded into second leg portion 78. Without a threaded attachment to second flange portion 61, tightening of screws 90 and 91 causes fixed frame component 25 to be drawn against the surface of wall 15, thereby adjusting a distance between first flange portion 60 and facer portion 27 in order to securely attaching hinge jamb component 25 to wall 10. Once all the fixed frame members are secured, preferably in a corresponding manner to the fixed hinge jamb member 25 as described, the other frame members can be slid into place and joined by the tongue and groove connections in a manner known in the art.

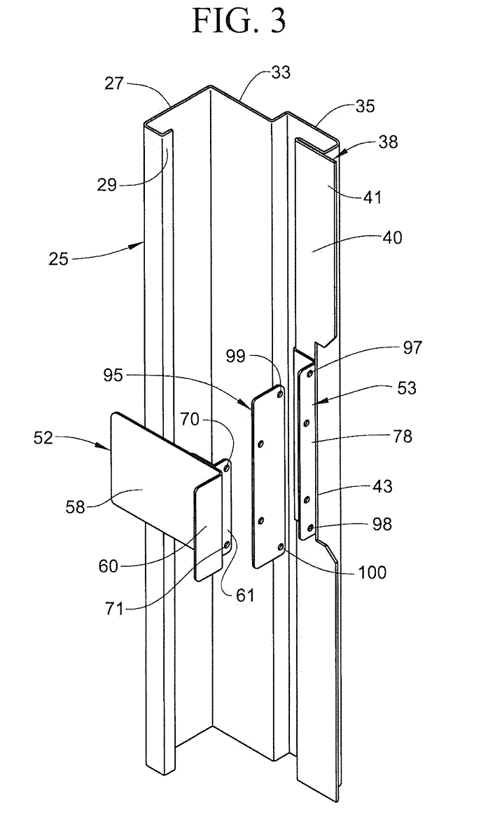

In further accordance with the present invention as shown in FIG. 3, an optional spacer plate 95 can be installed between second leg portion 78 and second flange portion 61 in order to alter the width of the overall door frame assembly 2, thereby accommodating various width tolerances for door opening 5. In one preferred embodiment, the second leg portion 78 and spacer plate 95 are preferably pre-formed with spaced holes 97, 98 and 99, 100 respectively, which can be aligned to receive mechanical fasteners (not shown) to fix spacer plate 95 as an extension of second leg portion 78. Thereafter, spacer plate 95 can be interconnect to second flange portion 61 in a manner directly corresponding to that described above with respect to second leg portion 78. At this point, it should be noted that one set of holes 97-100, such as holes 99 and 100, could be slotted to allow relative adjustment between spacer plate 95 and second leg portion 78 to establish a variable length extension is accommodate potential variations is opening widths. In any case, this potential variation will be discussed further herein.

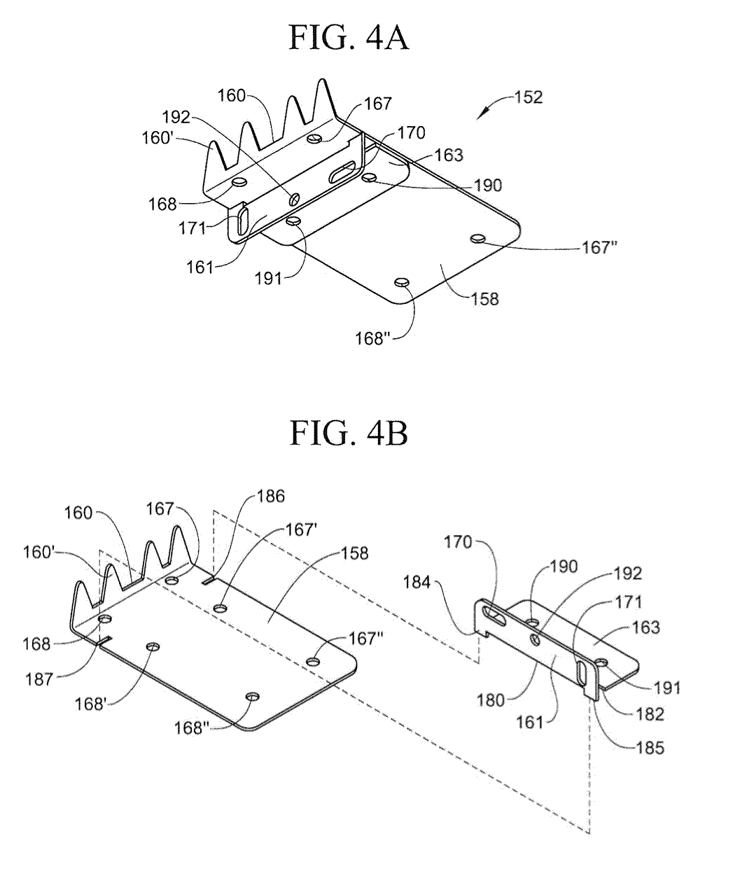

With particular reference to FIGS. 4 and 4B, a second embodiment of the invention will now be described wherein bracket 52 is replaced by a reconfigured bracket 152. As illustrated, bracket 152 includes an elongated main plate portion 158 from which projects two flange portions 160 and 161. In the most preferred form of this embodiment of the invention, bracket 152 if formed by bending a metal plate into a generally L-shaped configuration to establish main plate portion 158 and flange portion 160, with flange portion 160 extending substantially perpendicular to main plate portion 158. Instead of being a solid, generally rectangular-shaped plate, flange portion 160 preferably includes a plurality of spaced teeth members 160′.

As clearly illustrated, second flange portion 161 is provided at a position spaced along main plate portion 158 from first flange portion 161, with second flange portion 161 also extending substantially perpendicular from main plate portion 158, but in a direction opposite from first flange portion 160. As clearly shown in FIG. 4B, second flange portion 161 is actually part of an angled bracket section including a leg 163 which is welded or otherwise affixed to main plate portion 158 at a position spaced from first flange portion 160 such that first and second flange portions 160 and 161 are arranged in spaced, generally parallel planes. In addition to apertures 167 and 168 which generally correspond to apertures 67 and 68 of the first embodiment of the invention, main plate portion 158 of bracket 152 is provided with additional apertures 167′, 167″, 168′ and 168″. In addition, second flange portion 161 is formed with a plurality of spaced apertures 170 and 171, which are shown to preferably take the form of slots.

As clearly shown in these figures, second flange portion 161 is preferably bent along line 180 relative to leg 163, with leg 163 including cut lines, such as that indicated at 182, in order to establish projecting tabs 184 and 185 on second flange portion 161. To accommodate tabs 184 and 185, main plate portion 158 is formed with opposing cut-outs 186 and 187 between apertures 167, 168 and 167′, 168′ respectively. When assembling the overall bracket 152, leg 163 is positioned on main plate portion 158 with tabs 184 and 185 projecting into cut-outs 186 and 187. In addition, openings 190 and 191 formed in leg 163 are aligned with apertures 167′ and 168′ respectively. At this point, it is preferable to weld, such as by spot welding, leg 163 to main plate portion 158 to achieve the assembly shown in FIG. 4A, with the overall bracket 152 being interchangeably used with bracket 152 of the first embodiment. Finally, in one preferred form of the invention, second flange portion 161 is also provided with a hole 192 as another potential attachment point.

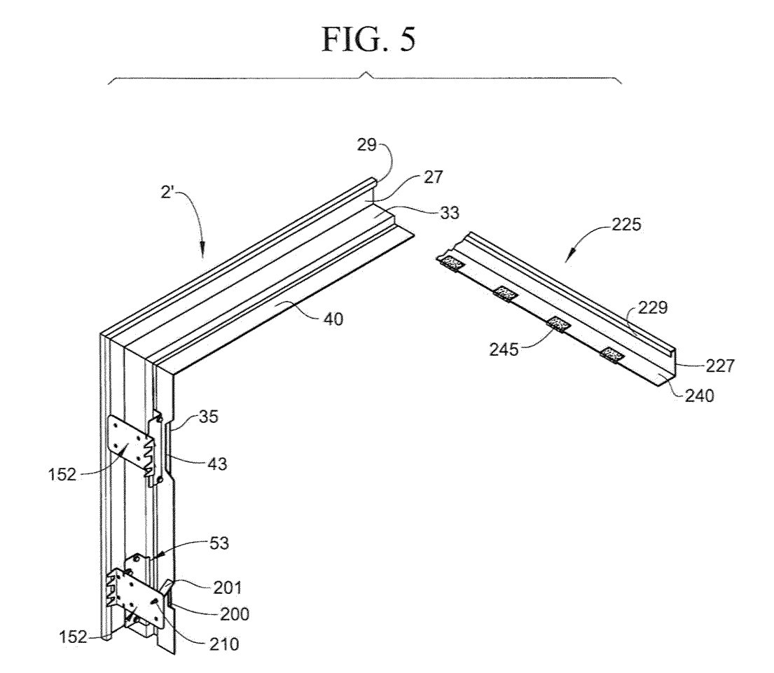

FIG. 5 illustrates an assembly similar to that set forth in FIG. 1 of an overall frame assembly 2′ which actually incorporates the multiple brackets 152. Preferably, for a door framing system, brackets 152 would be mounted at hinge locations in a manner directly corresponding to that of FIGS. 1 and 5 such that teeth 160′ are arranged between wall stud 10 and, for instance, wall covering 14. However, in addition to this overall bracket arrangement located at the hinges, it is also possible to utilize such an arrangement throughout the overall periphery of the door frame assembly, and even between the hinges on one side of the assembly. FIG. 5 illustrates such an arrangement wherein a bracket combination 53, 152 is employed a distance below the hinge area. In this particular arrangement, bracket 152 is rotated 180° and mounted between stud 10 and wall covering 15. Therefore, it is possible to reverse the direction or positions of the bracket assembly in order to further enhance the structural integrity and rigidity of the overall assembly.

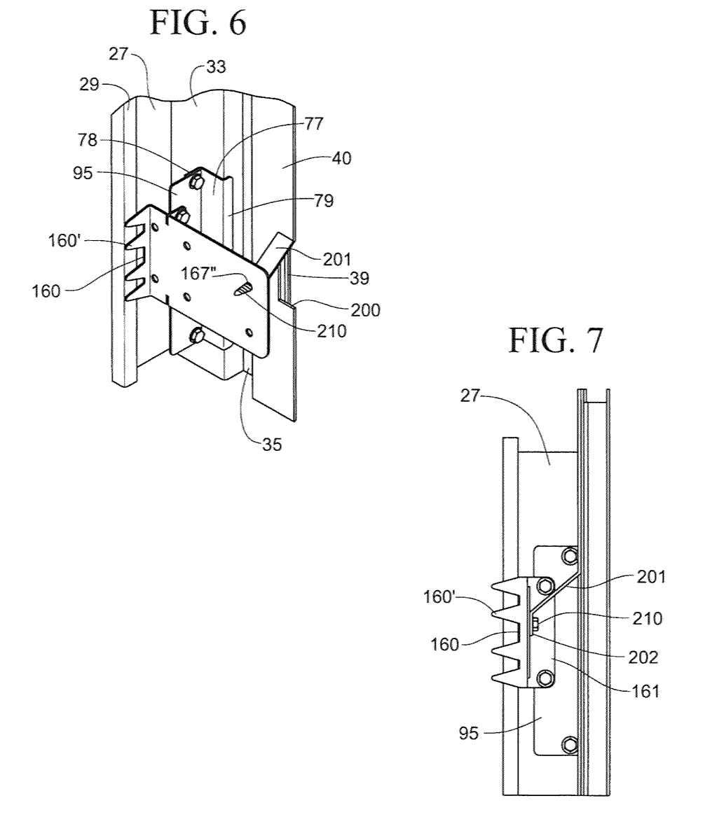

FIGS. 6 and 7 illustrate a preferred mounting for these auxiliary or reversed brackets which utilize spacers 95 in conjunction with supporting an end of main plate portion 158 which is spaced from flange portion 160. More specifically, in accordance with this aspect of the invention, out-turned portion 40 is lanced so as to establish a cut-out illustrated at 200. The lanced portion of out-turned portion 40 establishes a first cantilevered leg portion 201 and a second cantilevered leg portion 202. As shown in these figures, cantilevered leg portion 201 extends at an angle from out-turned portion 40, while leg portion 202 is arranged generally parallel to out-turned portion 40. A screw 210 is used to threadably attach leg portion 202 to main plate portion 158, such as through aperture 167″.

With this overall arrangement, the reversing of either bracket 52 or bracket 152 can enable the overall jamb assembly to be firmly mounted at each of wall coverings 14 and 15. The number of mounting brackets arrangements on each side can certainly vary with the size of the opening and the degree of rigidity desired, with the most preferred embodiment of a door assembly employing at least three brackets on the hinge jamb side, with two of the brackets located directly at the hinge as shown in FIG. 1 and another reversed bracket intermediate the upper and lower hinge located brackets as illustrated in FIG. 5.

As indicated above, door abutment portion 35 defines a channel 38 between in-turned portion 39 and out-turned portion 40. In order to complete the overall assembly, a facer member 225 is provided as shown in FIG. 5, with facer member 225 including a facer portion 227 and an in-turned edge portion 229 in a manner analogous to facer portion 27 and in-turned edge 29 discussed above. In addition, facer member 225 includes a leg portion 240 which adapted to be slidably received within channel 38. Basically, once fixed hinge jamb component 25 is mounted in the manner set forth in FIG. 1, leg portion 240 of facer portion 225 can be slid into a respective channel 38 until in-turned edge portion 229 abuts wall covering 14. In the most preferred embodiment of the invention, leg portion 240, being a non-load bearing member, is only frictionally retained within channel 38, thereby greatly enhancing the assembly and adjustability of the overall system. To enhance this frictional attachment in accordance with the invention, a plurality of high friction zones are established along the length of leg portion 240 as indicated at 245. In the most preferred embodiment, high friction zones 245 are defined by adhesively secured sandpaper or emery cloth pieces that are folded about leg portion 240 and provide a secure contact with both in-turned portion 39 and out-turned portion 40 for the final assembly.

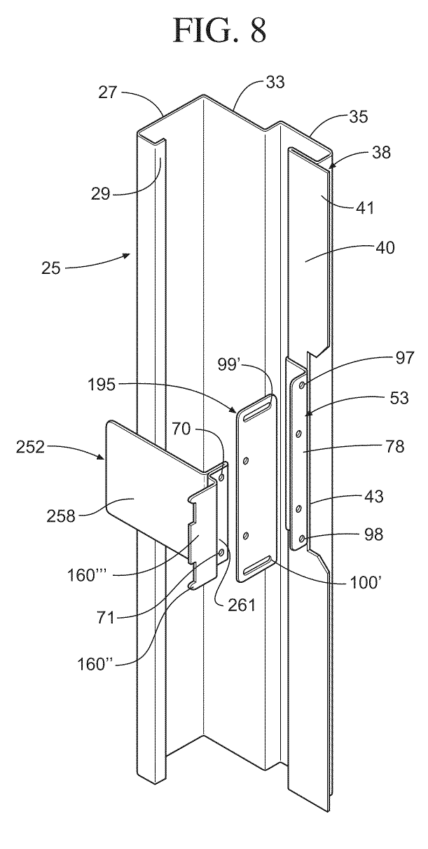

As indicated above, spacer plate 95 functions to accommodate varying widths of openings in which the adjustable frame assembly of the invention can be mounted. Although it is possible to use different size spacer plates 95 to accommodate for varying widths, another embodiment of the invention employs a spacer plate 195 having holes 99′ and 100′ in the form of slots as shown in FIG. 8. With this arrangement, the spacing between fixed component 25 and the opening can be readily adjusted and then spacer plate 195 can be secured to second bracket 53 in a desired location such as through the use of threaded fasteners (not shown). It should be readily understood that other structural variations can be employed. For instance, a first bracket 252 can be readily constructed by having a second flange portion 261 that is formed by a bent section of a main plate portion 258 as also shown in FIG. 8. Furthermore, this figure shows first bracket 252 to include end teeth 160″ and an elongated central tooth 160′″.

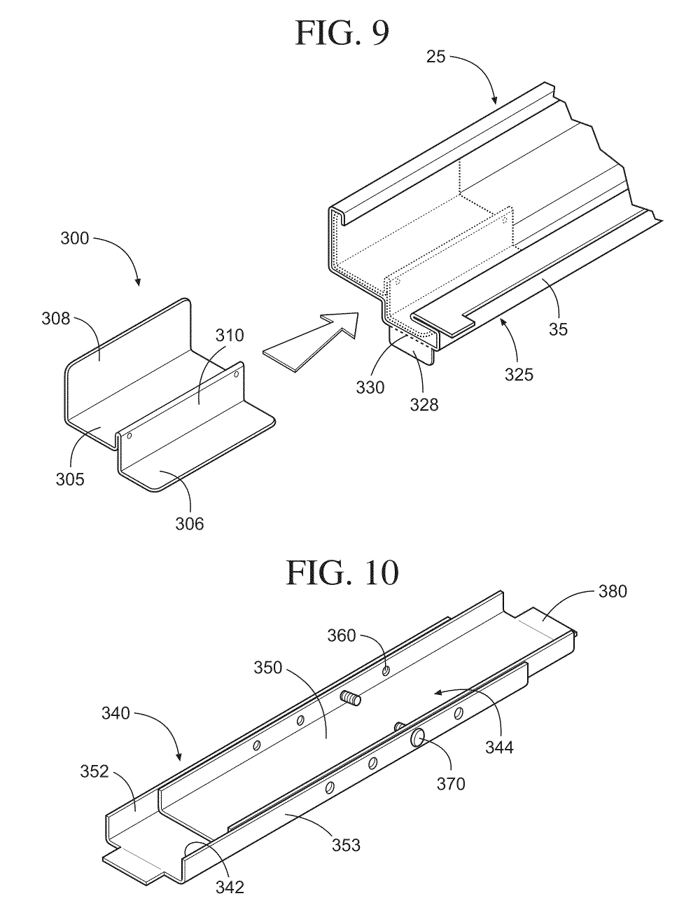

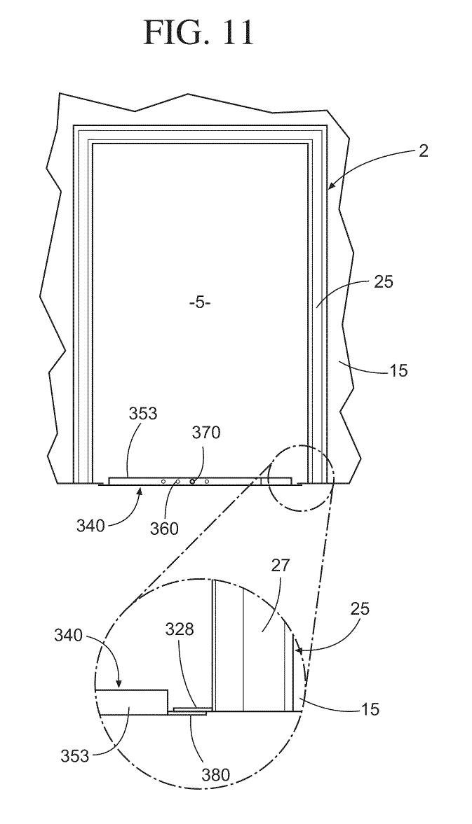

Further illustrated in FIG. 9 is the potential inclusion of a reinforcing insert 300 having substantially planar but offset body portions 305 and 306, along with an end upright 308 and a central upright 310. Basically, reinforcing insert 300 is preferably utilized in connection with frame component 25 being a door opening such that each opposing frame component 25 includes a respective free end 325 into which reinforcing insert 300 is positioned and secured, such as by welding; to provide for structural reinforcement at the location of free end 325, particularly for use in connection with hinges and the additional force placed on the first frame component 25 when attaching the second frame component 225. That is, in connection with a door assembly, the overall frame would be generally an inverted U-shape (illustrated in FIG. 11) and the upper crosspiece of the U-shape would provide substantial structural reinforcement for the attachment of the second frame member 225 in this location, but reinforcing insert 300 would be utilized to provide additional support at each free end 325. As additionally shown in FIGS. 9-11, again particularly in connection with a U-shaped door frame having free ends 325, it is preferred to provide each free end 325 with an in-turned tab 328. In the most preferred form of the invention, tab 328 is simply formed by bending an extension of stop or abutment portion 35, while also providing a series of perforations 330 along the bend seam. Tabs 328 are utilized in combination with a shipping support 340 (best shown in FIGS. 10 and 11) which interconnects the free ends 325 of the U-shape frame to provide enhanced support for shipping and storage. Obviously, such an arrangement would not be necessary in connection with a rectangular or square window frame constructed in accordance with the present invention but is quite advantageous in connection with a U-shaped door frame. In any case, as shown, shipping support 340 is established by a pair of nesting U-shaped channels 342 and 344, each of which includes a base 350 and upstanding walls 352 and 353. Upstanding walls 352 and 353 are provided with aligned apertures 360 which are adapted to receive fasteners 370 in order to establish a desired length for shipping support 340. The ends of shipping support 340 are provided with flanges 380, each of which is secured to a respective tab 328 such as by welding. After a door frame constructed in accordance with the present invention is mounted, fasteners 370 can be removed and each U-shaped channel 342, 344 pivoted up and down in order to force a respective tab 328 to snap off from a respective free end 325 adjacent perforations 330 to establish a finished doorway portal.

With the above construction, it should be readily apparent that the adjustable frame assembly of the invention can be assembled in an efficient and sturdy manner, while accommodating door opening variations in both thickness and width. Again, although one preferred embodiment of the invention is associated with an adjustable door frame assembly, the overall invention is directed to an adjustable frame assembly for various building openings such that, instead of defining an opening for a door, the assembly could be readily utilized within a building to establish an interior window or other closable opening. Basically, the mounting of the frame components remain the same between the various different uses, although the actual configuration of the frame components could change. For instance, in the case of framing an interior window opening, the region at door abutment or stop portion 35 would be reconfigured to accept and retain one or more panes of glass. Importantly, the invention provides an extremely effective way to establish a fire rated building opening while utilizing a frame assembly that is easy to install and which can be readily adjusted to accommodate varying thicknesses of the walls in which the openings are formed. Therefore, although described with reference to preferred embodiments of the invention, it should be readily understood that various changes and/or modifications can be made to the invention without departing from the spirit thereof. Instead, the invention is only intended to be limited by the scope of the following claims.

We claim:

1. In a building having an opening defined, at least in part, by a wall covering secured to a wall stud, an adjustable frame assembly extending about at least a portion of the opening comprising:
a first frame component including a first facer portion extending along one side of the portion of the opening and an inside section extending within the opening;
a first bracket having a first flange portion extending outside the opening, and a second flange portion projecting inside the opening;
a second bracket extending from the fixed frame component;
at least one connector adjustably securing the second flange portion of the first bracket to the first frame component through the second bracket such that the first frame component is secured to the wall stud through the first and second brackets with a distance between the first facer portion and the first flange portion being adjustable; and
a second frame component including a second facer portion extending along an opposing side of the portion of the opening and a leg portion connected to the first frame component.

2. The adjustable frame assembly according to claim 1, wherein the first flange portion of the first bracket is positioned between the wall stud and the wall covering.

3. The adjustable frame assembly according to claim 2, wherein the first bracket further includes a main plate portion from which the first and second flange portions extend in opposing directions.

4. The adjustable frame assembly according to claim 3, wherein the first and second flange portions also extend in substantially parallel, offset planes.

5. The adjustable frame assembly according to claim 4, wherein the second flange portion is formed separate from and attached to the main plate portion, with the main plate portion being formed with a cut-out and the second flange portion having a tab received in the cut-out.

6. The adjustable frame assembly according to claim 3, wherein the first flange portion is formed with a plurality of teeth for positioning the first flange portion between the wall stud and the wall covering.

7. The adjustable frame assembly according to claim 1, further comprising a cantilevered leg extending from the first frame component at a position spaced from the second bracket, said first bracket being further attached to the first frame component through the cantilevered leg.

8. The adjustable frame assembly according to claim 1, wherein the at least one connector comprises a screw extending through the second flange portion and being threadably attached to the second bracket.

9. The adjustable frame assembly according to claim 1, further comprising multiple, reverse positioned sets of the first and second brackets to fixedly secure the first frame member in the opening.

10. The adjustable frame assembly according to claim 1, further comprising a spacer plate interposed between the first and second brackets, wherein the spacer plate is attached to the second bracket and the first bracket is attached to the spacer plate in order to indirectly secure the first bracket to the first frame component.

11. The adjustable frame assembly according to claim 10, wherein the spacer plate is adjustably attached to the second bracket in order to selectively vary a distance between the inside section of the first frame component and the first bracket.

12. The adjustable frame assembly according to claim 1, wherein the inside section of the first frame component is formed with an elongated channel which frictionally receives the leg portion of the second frame component in order to connect the second frame component to the first frame component.

13. The adjustable frame assembly according to claim 12, further comprising a plurality of high friction elements provided at spaced locations along the leg portion of the second frame member for maintaining the leg portion within the channel.

14. The adjustable frame assembly according to claim 1, wherein the frame assembly constitutes a substantially U-shaped door frame having opposing, lower free ends, said adjustable frame assembly further comprising a reinforcing plate positioned within and conforming to the first frame component directly adjacent one of the lower free ends.

15. The adjustable frame assembly according to claim 14, further comprising a pair of anchor members and a cross support readily removably interconnecting the lower free ends of the door frame.

16. The adjustable frame assembly according to claim 15, wherein each anchor member is connected to a respective lower end along a connection line having a plurality of perforations.

17. In a building having an opening defined, at least in part, by a wall covering secured to a wall stud, a method of mounting an adjustable frame assembly about at least a portion of the opening comprising:
positioning a first flange portion of a first bracket along an outside wall portion of the opening;
positioning a first frame component such that a first facer portion of the first frame component extends along one side of the portion of the opening while an inside section of the first frame component extends within the opening;
adjustably securing a second flange portion of the first bracket to a second bracket extending from first frame component toward the wall stud such that the first frame component is secured to the wall stud through the first and second brackets with a distance between the first facer portion and the first flange portion being adjustable;
positioning a second frame component such that a second facer portion of the second frame component extends along an opposing side of the portion of the opening; and
connecting a leg portion of the second frame component to the first frame component.

18. The method of claim 17, further comprising: interposing a spacer member between the first and second brackets by attaching the spacer plate to the second bracket and attaching the first bracket to the spacer plate in order to indirectly secure the first bracket to the first frame component.

19. The method of claim 18, further comprising: adjustably attaching the spacer member to the second bracket to vary a distance between the inside section of the first frame component and the first bracket.

20. The method of claim 17, further comprising:
forming the first frame component in a U-shape having a pair of free ends;
directly interconnecting the free ends with a pair of anchor members and a cross support; and
snapping off the pair of anchor members from the first frame component upon mounting the frame assembly about the opening.
